(19) United States
(12) Patent Application Publication
(10) Pub. No.: US 2019/0077630 A1
(43) Pub. Date: Mar. 14, 2019

(54) SYSTEM AND METHOD OF INITIATING A HALL AND CAR CALL FOR AN ELEVATOR SYSTEM

(71) Applicant: Otis Elevator Company, Farmington, CT (US)

(72) Inventors: Ashley Chapman, Plainville, CT (US); Bradley Armand Scoville, Farmington, CT (US)

(21) Appl. No.: 15/750,489

(22) PCT Filed: Aug. 4, 2016
(86) PCT No.: PCT/US2016/045469

§ 371 Date: Feb. 5, 2018

Related U.S. Application Data
(60) Provisional application No. 62/201,879, filed on Aug. 6, 2015.

(51) Int. Cl. B66B 1/46

(52) U.S. Cl. CPC B66B 1/468; B66B 2201/4653; B66B 2201/4615

(57) ABSTRACT

A system and method of initiating a hall and car call in an elevator system including at least one elevator fixture in communication with an elevator control system, wherein the at least one elevator fixture includes a fixture communication device disposed therein. The method including the steps: operating the mobile device to receive a travel request, operating the mobile device to transmit a travel signal based on the travel request, operating the at least one elevator fixture to receive the travel signal, and operating the at least one elevator fixture to activate a call button based on the travel signal.

### CROSS-REFERENCE TO RELATED APPLICATIONS

The present application is an international patent application, which claims priority to U.S. Provisional Patent Application Ser. No. 62/201,879, filed Aug. 6, 2015, and having the title “SYSTEM AND METHOD OF INITIATING A HALL AND CAR CALL FOR AN ELEVATOR SYSTEM,” which is herein incorporated in its entirety.

### TECHNICAL FIELD OF THE DISCLOSED EMBODIMENTS

The presently disclosed embodiments generally relate to elevator systems and more specifically, a system and method of initiating a hall and car call for an elevator system.

### BACKGROUND OF THE DISCLOSED EMBODIMENTS

Modern elevator systems are essential in multi-story buildings. Ideal use of an elevator system requires efficient and convenient means of requesting and dispatching elevator service. Generally, a passenger seeking elevator service must first initiate service via an elevator fixture located in the hallway immediately near an elevator (or a bank of elevators). Once the elevator car arrives the passenger boards and then selects a destination floor from a number of buttons on a car fixture.

Once the request for service is made, the passenger may have to wait up to several minutes for the car to arrive, and in certain situations, access to the car buttons may be obstructed. There is therefore a need for a more convenient and faster method of initiating an elevator call and selecting a desired destination floor.

### SUMMARY OF THE DISCLOSED EMBODIMENTS

In one aspect, an elevator system is provided. The elevator system includes an elevator fixture operably coupled to an elevator control system, and a fixture communication device operably coupled to the elevator fixture, the fixture communication device operable to at least wirelessly communicate information. In an embodiment, the fixture communication device includes at least one of a transmitter and a receiver. In any of the preceding embodiments, the elevator fixture includes a hall fixture. In this embodiment, the fixture communication device is configured to receive a first travel signal from a mobile communication device and to execute a hall call in response thereto, wherein the first travel signal is indicative of a direction of travel.

In another embodiment, the elevator fixture includes a car fixture. In this embodiment, the fixture communication device is configured to receive a second travel signal from a mobile communication device and to execute a car call in response thereto, wherein the second travel signal is indicative of a destination floor.

In one aspect, an elevator fixture is provided. The elevator fixture includes a housing, at least one responsive interface disposed within the housing, and a fixture communication device disposed within the housing and operably coupled to the at least one responsive interface.

In any embodiment of the elevator fixture, the communication device includes at least one of a transceiver and a receiver. In any embodiment of the elevator fixture, the fixture communication device is configured to receive a travel signal from a mobile device communication device, wherein the travel signal is indicative of at least one of a direction of travel and a destination floor. In any embodiment of the elevator fixture, the at least one responsive interface is selected from a group consisting of: a hall fixture and a car fixture.

In one aspect, a method of initiating a hall call and car call the elevator system is provided. The method includes the steps of operating a mobile device to receive a travel request, operating the mobile device to transmit a travel signal based on the travel request, operating the at least one elevator fixture to receive the travel signal, and operating the at least one elevator fixture to activate a call button based on the travel signal.

In any embodiment of the method, initiating a travel request includes operating a program stored on the mobile device to receive a travel request based in part on a selected a destination floor. In any embodiment of the method, the travel signal is indicative of at least one of a direction of travel and a destination floor. In any embodiment of the method, the at least one elevator fixture is chosen from a group consisting of: a hall fixture and a car fixture.

Other embodiments are also disclosed.

### BRIEF DESCRIPTION OF DRAWINGS

FIG. 1 illustrates a schematic drawing of an elevator system; and

FIG. 2 illustrates a schematic flow diagram of a method for initiating a hall and car call for an elevator system.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

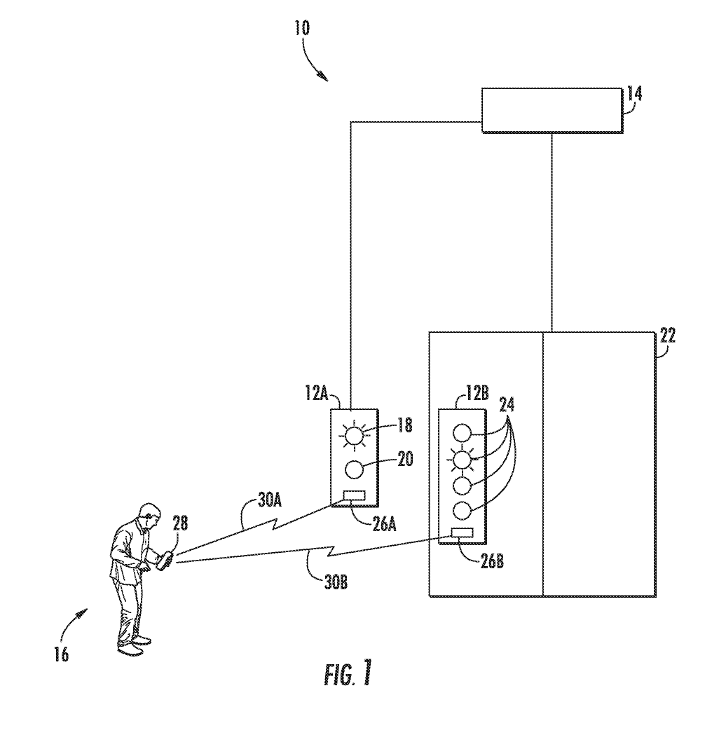

FIG. 1 illustrates selected portions of an elevator system, generally indicated at 10. The elevator system 10 includes at least one elevator fixture 12 operably coupled to an elevator control system 14. In one embodiment, the at least one elevator fixture 12 includes a hall fixture 12A. In another embodiment, the at least one elevator fixture 12 includes a car fixture 12B. The elevator control system 14 is configured to coordinate all aspects of elevator service such as travel, speed, and accelerating, decelerating, door opening speed and delay, leveling and hall fixture signals.

For example, when a passenger 16 typically wishes to initiate service for an elevator, the passenger 16 approaches the hall fixture 12A and presses the higher placed button 18 (i.e. up button) to request travel in the up direction, and presses the lower placed button 20 (i.e. down button) to request travel in the down direction.

The elevator control system 14 dispatches an elevator car 22 to the requested floor. Generally, after the arrival of the elevator car 22, the passenger 16 boards and then selects a button 24 from the car fixture 12B indicative of the passenger's destination floor. The elevator car 22 then travels to the requested destination floor, where upon arrival the passenger 16 exits the elevator car 22.

In the present embodiment, the at least one elevator fixture 12 includes a fixture communication device 26 disposed therein. In an embodiment, the fixture communication device 26 includes at least one of a transceiver and a receiver. For example, the fixture communication device 26 may include such transceivers as a BLUETOOTH LE enabled module to name one non-limiting example. The fixture communication device 26 is further configured to allow the passenger 16 to wirelessly communicate to the at least one elevator fixture 12.

In the present embodiment, the passenger 16 operates an application program stored on a mobile device 28 to request elevator service. The mobile device 28 also includes a mobile device communication device (not shown) that is configured to wirelessly communicate to the fixture communication device 26. It will be appreciated that the mobile device 28 may be any mobile device operable to perform the functions disclosed herein, for example, a mobile telephone, tablet device, or any device capable of being carried by a person outside of a home, or other structure, to name a few non-limiting examples.

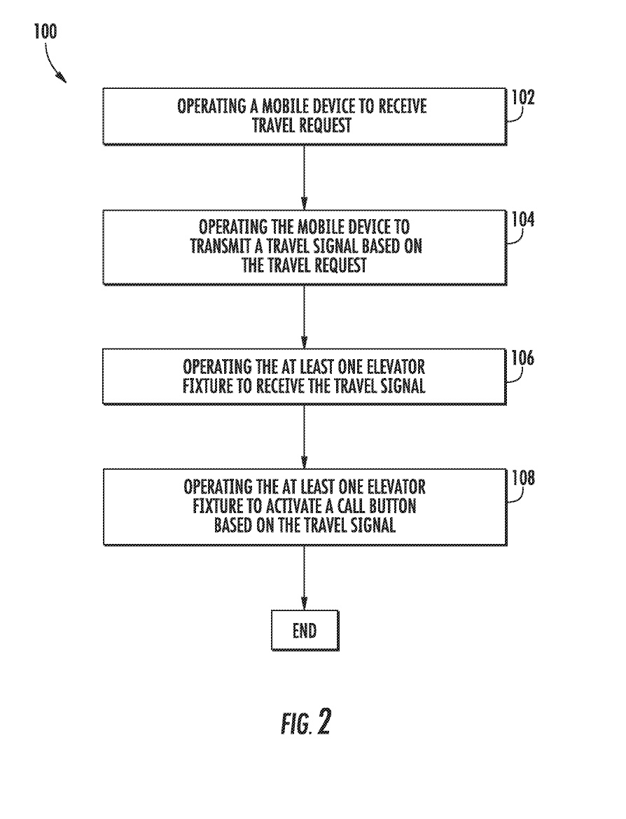

FIG. 2 illustrates a method, generally indicated at 100, of initiating a hall call and car call the elevator system 10. The method 100 includes step 102 of operating the mobile device 28 to receive a travel request. In an embodiment, initiating a travel request includes operating a program stored on the mobile device to receive the travel request based in part on a selected destination floor.

The method 100 further includes step 104 of operating the mobile device 28 to transmit a travel signal based on the travel request. In an embodiment, the travel signal includes a first travel signal 30A, wherein the first travel signal 30A is indicative of a direction of travel. In another embodiment, the travel signal includes a second travel signal 30B, wherein the second travel signal 30B is indicative of a destination floor.

The method 100 further includes step 106 of operating the at least one elevator fixture 12 to receive the travel signal 30. For example, fixture communication device 26A is operable to receive the first fixture signal 30A, and fixture communication device 26B is operable to receive the second travel signal 30B. The method 100 further includes step 108 of operating the at least one elevator fixture 12 to activate a call button, 18, 20, or 24 based on the travel signal.

An example of the method 100 disclosed herein includes a scenario where the passenger 16 enters a request to travel from floor 7 to floor 11 on the application stored in the mobile device 28. As the passenger 16 approaches the elevator system 10, the mobile device 28 transmits a travel signal, indicating a desire to travel in the up direction, to the hall fixture communication device 26A.

It will be appreciated that the hall fixture 12A may automatically determine the direction of travel based on the first travel signal. For example, the hall fixture 12A, knowing its position on floor 7, receives the first travel signal to floor 11. The hall fixture 12A receives the first travel signal to determine an up direction call is needed because the destination floor is greater than the current position.

Alternatively, the hall fixture 12A may transmit a signal representative of the current floor location (e.g. floor 7) of the passenger 16 to the mobile device 28. The passenger 16 may then only be required to enter a desired destination floor (e.g. floor 11). As the passenger 16 approaches the elevator system 10, the mobile device 28 transmits a first travel signal, indicating a desire to travel in the up direction, to the hall fixture communication device 26A.

In another example, if the passenger 16 typically initiates an elevator call from floor 7 to floor 11 at 12:00 PM, the mobile device 28 may begin to transmit a travel signal representative of an up hall call and a floor 11 car call within an hour of the designated time. It will be appreciated that the travel signal may begin at any time prior to the designated time. As the passenger 16 approaches the elevator system 10, the mobile device 28 transmits the travel signals indicative of the up direction hall call and the floor 11 car call.

Upon receipt of the travel signal, the hall fixture 12A activates and illuminates the up button 18 as a confirmation that the passenger 16 has requested travel in the up direction. It will be appreciated that the passenger 16 may also request travel in the down direction, in which case, the first travel signal would indicate travel in the down direction. As such, the hall fixture 12A activates and illuminates the down button 20.

Upon arrival of the elevator car 22, the passenger 16 boards the elevator car 22 and the mobile device 28 transmits a second travel signal, indicating a desire to travel to floor 11, to the car fixture communication device 26B. Upon receipt of the second travel signal, the car fixture 12B activates and illuminates the car button 24 representing floor 11 as a confirmation that the passenger has requested travel to floor 11. It will be appreciated that the passenger may request any floor serviced by the elevator system 10, in which case, the second travel signal would activate and illuminate the appropriate car button 24 representative of the requested floor. The elevator car 22 then travels to the requested destination floor, where upon arrival the passenger 16 exits the elevator car 22.

It will be appreciated that the elevator system 10 includes a fixture communication device 26 disposed within the at least one elevator fixture 12 to allow a passenger to quickly, and seamlessly request elevator service without the need for manually pressing buttons on a fixture.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. An elevator system comprising:
an elevator control system;
an elevator fixture operably coupled to the elevator control system; and
a fixture communication device operably coupled to the elevator fixture, the fixture communication device operable to at least wirelessly communicate information.

2. The elevator system of claim 1, wherein the fixture communication device comprises at least one of a transmitter and a receiver.

3. The elevator system of claim 1, wherein the elevator fixture comprises a hall fixture.

4. The elevator system of claim 1, wherein the fixture communication device is configured to receive a first travel signal from a mobile communication device and to execute a hall call in response thereto.

5. The elevator system of claim 4, wherein the first travel signal is indicative of a direction of travel.

6. The elevator system of claim 1, wherein the elevator fixture comprises a car fixture.

7. The elevator system of claim 1, wherein the fixture communication device is configured to receive a second travel signal from a mobile communication device and to execute a car call in response thereto.

8. The elevator system of claim 7, wherein the second travel signal is indicative of a destination floor.

9. A method of initiating elevator service for an elevator system including at least one elevator fixture in communication with an elevator control system, wherein the at least one elevator fixture includes a fixture communication device disposed therein, and a mobile device in communication with the fixture communication device, the method comprising:
(a) operating the mobile device to receive a travel request;
(b) operating the mobile device to transmit a travel signal based on the travel request;
(c) operating the at least one elevator fixture to receive the travel signal; and
(d) operating the at least one elevator fixture to activate a call button based on the travel signal.

10. The method of claim 9, wherein step (a) comprises operating a program stored on the mobile device to receive the travel request based in part on a selected destination floor.

11. The method of claim 9, wherein the travel signal is indicative of at least one of a direction of travel and a destination floor.

12. The method of claim 9, wherein the at least one elevator fixture is chosen from a group consisting of: a hall fixture and a car fixture.

13. An elevator fixture comprising:
a housing;
at least one responsive interface disposed within the housing; and
a fixture communication device disposed within the housing and operably coupled to the at least one responsive interface.

14. The elevator fixture of claim 13, wherein the communication device comprises at least one of a transceiver and a receiver.

15. The elevator fixture of claim 13, wherein the fixture communication device is configured to receive a travel signal from a mobile device communication device.

16. The elevator fixture of claim 13, wherein the at least one responsive interface is selected from a group consisting of: a hall fixture and a car fixture.

17. The elevator fixture of claim 13, wherein the travel signal is indicative of at least one of a direction of travel and a destination floor.
